(19) United States
(12) Patent Application Publication
(10) Pub. No.: US 2008/0235217 A1
(43) Pub. Date: Sep. 25, 2008

(54) System and method for creating, verifying and integrating metadata for audio/video files

(76) Inventors: Yugal K. Sharma, Washington, DC (US); Tad Richman, Washington, DC (US); Kurt Beyer, Mill Valley, CA (US); Bryan Michmerhuizen, Washington, DC (US)

Correspondence Address: Nields & Lemack, 176 E. Main Street, Suite #5, Westboro, MA, 01581, US

(21) Appl. No.: 12/075,845

(22) Filed: Mar. 14, 2008

Related U.S. Application Data
(60) Provisional application No. 60/918,538, filed on Mar. 16, 2007.

(51) Int. Cl. G06F 7/06; G06F 17/30

(52) U.S. Cl. 707/5; 707/E17.014

(57) ABSTRACT

The present invention discloses a system and method for insuring the integrity and format of metadata. In the preferred embodiment, a local database is created into which metadata information can be stored. Since the database is maintained locally, it can be guaranteed to have correct and complete metadata information. Metadata searches are preferably performed hierarchically, such that the local database is checked first for the required data. If the data is not resident in the local database, the traditional search of third-party databases is performed. Information retrieved from third-party databases is then verified, such as manually. Once the metadata has been checked and approved, the metadata is then stored locally. A set of rules is also created, which define the requirements and the file manipulations that must be preformed on the metadata for each type of target device.

This application claims priority of U.S. Provisional application Ser. No. 60/918,538 filed Mar. 16, 2007, the disclosure of which is incorporated herein by reference.

### BACKGROUND OF THE INVENTION

When compact discs are inserted into a personal computer, it is expected by the user that the media player will display the name of the song, the artist's name, and the name of the album. While this information is typically presented by the personal computer, it is actually not included on the CD itself.

In fact, tools exist that enable third party databases to be queried for the above-mentioned information, which is also known as metadata. Typically, the application, such as but not limited to Windows Media Player, supplies configuration information regarding the optical medium, via the internet. This configuration information includes the number of tracks on the disk and the length of each track. This information is found in the table of contents of the CD. This combination is nearly unique for each CD and allows the third party database to retrieve information specific to that disc. There are a variety of third-party database services that perform this operation, such as, but not limited to AMG, freedb.org and Gracenote.

Based on this information, the third-party database returns information or metadata, which may include the name of each track, the name of the album, the artwork on the cover of the disc, the year of release, and the genre. The returned metadata is then embedded into the data file, typically using standard data structures.

Unfortunately, this system is not perfect. There are various albums that are not in a particular third-party's database. In many other cases, there are inaccuracies, such as misspellings, and typographical errors.

For the consumer, these errors can be a minor annoyance. However, for those industries that rely on this information, such as businesses that convert audio and video data into alternate formats, the errors can lead to poor search and display performance on hardware user interfaces which leads to customer satisfaction issues. Accurate, consistent metadata can be as important to customer satisfaction as the quality of the audio or video data itself.

Therefore, it may become imperative to verify the accuracy of the metadata returned by the third-party database-services. Therefore, to process collections of CDs or DVDs, there must be a rigorous quality control (QC) step to ensure the data is tagged with complete, accurate, and consistent information. The time taken to perform this step is nontrivial and scales linearly with the number of collections that are processed in a given day. For businesses that process hundreds of thousands of discs monthly, the quality of the metadata, as well as the speed with which it can be accurately tagged to the data, are important metrics that can directly affect the amount of business such a venture can support.

For the audio or video data to be tagged effectively, consideration must also be given to the target device for final storage/playback. Target devices include, but are not limited to iPod, media server, etc. In addition, target devices may have particular metadata requirements. These requirements may include, but are not limited to, character length, special character handling, and unique metadata fields, etc. These requirements must be known so that metadata tagging will yield the maximum information content during playback. Typically, queries made to third-party databases do not allow for retrieval of metadata that follow device specific standards. This typically requires a second manual QC procedure to ensure that not only are the retrieved metadata results accurate and consistent, but that they are now properly formatted with respect to the target device. This can be a very time consuming, error-prone manual process that can become the rate-limiting step for legacy media conversion.

In addition, different audio and video data formats require metadata to be embedded in a number of different ways. Therefore, flexibility in tagging mechanisms is also an important consideration. This becomes especially important as standards change or if custom fields are required for special requests.

Clearly, a better method of retrieving metadata, verifying its accuracy and completeness, and manipulating it into the proper format is required.

### SUMMARY OF THE INVENTION

The problems of the prior art have been solved by the present invention, which discloses a system and method for insuring the integrity and format of metadata. In the preferred embodiment, a local database is created into which metadata information can be stored. Since the database is maintained locally, it can be guaranteed to have correct and complete metadata information. Metadata searches are preferably performed hierarchically, such that the local database is checked first for the required data. If the data is not resident in the local database, the traditional search of third-party databases is performed. Information retrieved from third-party databases is then verified both automatically and manually. Once the metadata has been checked and approved, the metadata is then stored locally. A set of rules is also created, which define the requirements and the file manipulations necessary for each type of target device.

### BRIEFLY DESCRIPTION OF THE DRAWINGS

FIG. 1 illustrates a representative embodiment of the present invention.

### DETAILED DESCRIPTION OF THE INVENTION

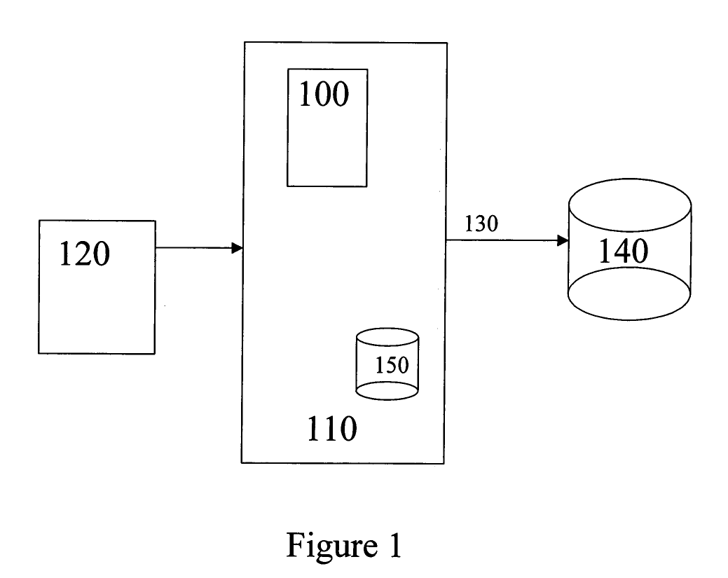

FIG. 1 illustrates a representative embodiment of the present invention. Software application 100 is resident in the memory of computing system 110. The computing system is equipped with an input device 120, so as to receive legacy media, such as Compact Discs, DVDs, and other media, and a network connection 130. The network connection 130 allows the computing system 110 to communicate via the internet to remote websites, such as third-party databases 140. Additionally, the computing system 110 is able to access a local database 150. In one embodiment, the local database 150 is contained on the storage device of the computing system 110. In another embodiment, the local database 150 is located relatively close to the computing system 110 and can be shared by multiple computing systems.

The software application 100 is designed to receive data from the legacy media presented to the input device 120. For example, data contained on a Compact Disc conforms to the CDDA standard, which specifies the digital encoding standards used. The software application 100 then converts this data into a different digital format (such as .MP3, .AAC, etc). In addition to simply converting the incoming data to another digital format, the software application 100 appends metadata to the newly formatted data.

In one embodiment, the software application 100 queries at least one third-party database 140, such as any of those enumerated above. These third-party databases 140 are addressable via the internet, and can be accessed typically via the network connection 130. The query results are then returned by the third-party database 140 to the software application 100, such as via the network connection 130. As described above, these query results, while often correct, may include typographical errors, or may be incomplete or missing. To eliminate the uncertainty inherent in these query results, an inspection of the returned query results may need to be performed. In one embodiment, human intervention is required to review the returned query results and compare them to the actual data, as displayed on the physical disc (or jewel case). As a consequence of this inspection, the query results may be determined to be correct in the form that they were returned. In this case, the results are simply copied into the local database 150. Alternatively, the inspection may yield errors, either minor or major in nature. In this case, the query results need to be edited (or constructed) manually. Again, once this is completed, the data is written into the local database 150. This process, while time consuming, insures that the local database 150 contains verified accurate metadata.

In another embodiment, a plurality of third-party databases 140 is queried. If the query results returned from these third-party databases 140 are identical, the confidence increases that the returned query data is correct. In fact, the software application 100 may compare the returned query data automatically. The confidence in the returned query results increases with each successful compare operation. In one embodiment, the software application 100 automatically determines that the returned query results are correct when a sufficient number of compare operations have succeeded. For example, if three different third-party databases 140 all return identical query results, the software application 100 may conclude that this data must be correct. In such a case, the returned results are copied into the local database 150, without having to be manually inspected. The number of compare operations and the number of databases which are queried may vary, but are all within the scope of the invention.

Having described the process by which accurate query results are entered into the local database 150, a description of the other functions of the software application is necessary. Assume at an earlier time, the software application 100 has encountered a particular CD title. The above-described steps were completed at that time, and the local database 150 now contains a known accurate copy of the metadata related to that CD title. When that same CD title is presented to the input device 120 for processing by the software application 100 at a later time, the software application 100 first checks the local database 150. This local database 150 can be organized in a number of ways. In one embodiment, it is queried by presenting it with the same configuration information required by the third-party databases 140 (i.e. number of tracks, length of each track, etc). In another embodiment, this configuration information is supplemented by supplying the type of target device, in cases where the metadata for a particular CD may differ based on the target device.

The local database 150 accepts these presented parameters and returns the metadata which had been previously stored in the database 150. The software application 100, noting that the local database 150 returned actual data, is aware that it need not conduct a query of third-party databases 140. This metadata is then used by the software application 100, with full confidence in its accuracy.

Alternatively, if the local database 150 did not have the requested metadata, it would return an indicator to the software application 100 noting this fact. The software application 100 is then aware that it must query the third-party databases 140 as described above.

While one of the described embodiments allows multiple local database 150 entries for the same CD based on the type of target device, other embodiments are envisioned. For example, in another embodiment, the local database 150 stores metadata that is independent of the type of target device. The software application 100 also includes sets of rules that can be applied to this generic metadata to allow it to conform to any type of target device. In this way, the user or operator can select the target device type, such as by entering the target device type of selecting the device from a drop-down menu. Once the target device is entered, a specific set of rules is automatically applied to the metadata. Since this rule set application is automatic, overhead associated with inspecting and verifying the accuracy of this metadata is essentially non-existent.

A simple example of a target device based rule set would be one based on character length. For example, a particular target device may be capable of displaying only 30 characters. Thus, when this target device is selected, the software application 100 is instructed to truncate the metadata accordingly. In one embodiment, automatic routines to remove extraneous words (such as a, an, and, the, etc.) are used. If the length of the resulting metadata is still greater than the limitation imposed by the target device, a second routine can be used to truncate fields, preferably from the end.

Rules can also be defined which are applied to all metadata, regardless of target device. An example of such a global rule set would be a rule which capitalizes the first letter of every word. In this case, a routine parses the metadata, identifies the first letter of every new word, and insures that this letter is capitalized. Another may be the handling of sets of CDs or DVDs in order to create a standard presentation, such as “Disc 1 of 4.” The creation of such a rule is within the capability of those of ordinary skill in the art.

Once the metadata has been provided and the appropriate rules have been applied, the metadata is then included with the extracted audio or video data from the Compact Disc to create a digitally formatted file. This format may be MP3, AAC, or another digital format. This file is then usable by the target device.

In addition to using a set of rules to properly manipulate the metadata, rules can also be used to append custom tags to data files and to append these tags automatically in accordance with the format extension of the file being tagged. For example, the metadata may include the album cover artwork. Depending on the type of target device and the file format being created, the encoding or formatting of this artwork may vary. For example, the encoding of the graphics, the size of the graphics and the available color palate may vary depending on the type of target device.

Additionally, rules can be employed to append passive Digital Rights Management strategies, such as watermarking. As with artwork, the encoding of the watermarking may vary depending on the type of target device. The insertion of watermarking may be required to ensure compliance with various licensing agencies. Once rules are created for each type of target device, artwork and watermarking can be inserted without any manual inspection.

Finally, software within the application can track all metrics surrounding the amount of time and effort used in verifying the quality of the metadata. These results can be stored in a database, where they can be analyzed with efficiency studies to achieve optimization of quality control strategies and implementations.

The present invention can also be used with a system for converting legacy media types. Such a system is described in co-pending application “High Throughput System for Legacy Media Conversion”, the disclosure of which is hereby incorporated by reference.

What is claimed:

1. A method of providing metadata for inclusion in a digitally formatted file, comprising:
a. Providing a computing system comprising a storage element comprising a local database, a media reader and a network connection adapted to communicate with a third party database;
b. Reading said compact disc using said media reader to extract identifying information about said compact disc;
c. Using said identifying information to query said local database to obtain disc specific information; and
d. Using said identifying information to query said third party database to obtain said disc specific information if said local database does not have said information.

2. The method of claim 1, wherein said disc specific information obtained from said third party database is verified before being added to said local database.

3. The method of claim 1, wherein said disc specific information is obtained from a plurality of third party databases.

4. The method of claim 3, wherein said disc specific information obtained from said plurality of third party databases is compared and said information is added to said local database based on said comparison.

5. The method of claim 1, wherein said computing system is adapted to modify said disc specific information prior to incorporation in said digitally formatted file.

6. The method of claim 5, wherein said computing system comprises rules defining said modifications to be made.

7. The method of claim 5, wherein a target device is identified prior to said inclusion and said computing system comprises rules specific to said target device defining said modifications to be made.
